(19) United States
(12) Patent Application Publication
(10) Pub. No.: US 2006/0262390 A1
(43) Pub. Date: Nov. 23, 2006

(54) Microscope with antimicrobial surface

(75) Inventor: Vincent Vaccarelli, Getzville, NY (US)

Correspondence Address: S. Peter Konzel, Esq.;Simpson & Simpson, PLLC, 5555 Main Street, Williamsville, NY, 14221, US

(73) Assignee: Leica Microsystems Wetzlar GmbH, Wetzlar (DE)

(21) Appl. No.: 11/131,549

(22) Filed: May 18, 2005

(51) Int. Cl. G02B 21/00

(52) U.S. Cl. 359/368; 359/896

(57) ABSTRACT

A microscope is disclosed wherein at least a surface portion of a microscope, for example, the stand, the stage, the eyepiece or the several operating elements, is provided with an antimicrobial outer surface.

The present invention relates generally to microscopes; and more particularly; to microscopes comprising an antimicrobial surface.

### BACKGROUND OF THE INVENTION

In educational and laboratory environments many people may use a same microscope which can cause harmful organisms to be transmitted from one person to another.

The Hospital Bulletin; February/March 2005; page 38 to 44, discloses the use of a protection on devices used in a hospital to minimize the risk of cross infection. The protection is not used on a microscope.

### BRIEF SUMMARY OF THE INVENTION

The object of the present invention is to prevent the spread of harmful organisms and prevent the users of microscopes from getting ill and missing classroom time or work time.

Currently, standard plastic or metal materials are typically used which can retain the harmful organisms or allow their survival and transmittal from person to person.

The use of inorganic antimicrobial compounds and processes, such as BioCote™ and the BioCote™ process, on the microscope touch points, like focus knobs, stage controls, power switch, eyetubes, condenser control or nosepiece grip, helps to solve the above problem.

The above object is solved by a microscope which comprises a plurality of components, consisting essentially of a stand, a stage mounted to said stand, an eyepiece provided at said stand and several operating elements, for changing microscopic parameters, wherein at least a surface portion of the stand, the stage, the eyepiece or the several operating elements is provided with an antimicrobial outer surface.

The antimicrobial outer surface can be defined by a coating, a paint or a finish. Additionally, the antimicrobial outer surface can be provided by integrating the antimicrobial compound into the structural matrix of a microscope component during fabrication thereof, for example, a during injection molding of the microscope components.

In another embodiment only selected components of the microscope are provided with an antimicrobial surface. The components are the stage controls, the focus knobs, the at least one power switch, the eye tubes, the condenser control ring or a nosepiece grip.

In still yet another embodiment, an antimicrobial outer surface can be provided on the surfaces of a microscope that are not typically contacted by a microscope user during regular use; for example, a microbial surface may be provided on internal surfaces to prevent the growth of microbes, fungi, or other micro-organisms, etc. that may affect microscope performance, e.g. lens tubes, etc.

### BRIEF DESCRIPTION OF THE DRAWINGS

These and other objects, features and advantages of the invention will become readily apparent to one having ordinary skill in the art upon study of the following detailed description in view of the drawings and appended claims in which:

FIG. 1 is a perspective view of a microscope;

FIG. 2 is a side view of a microscope; and

FIG. 3 is a front view of a microscope.

### DETAILED DESCRIPTION OF THE INVENTION

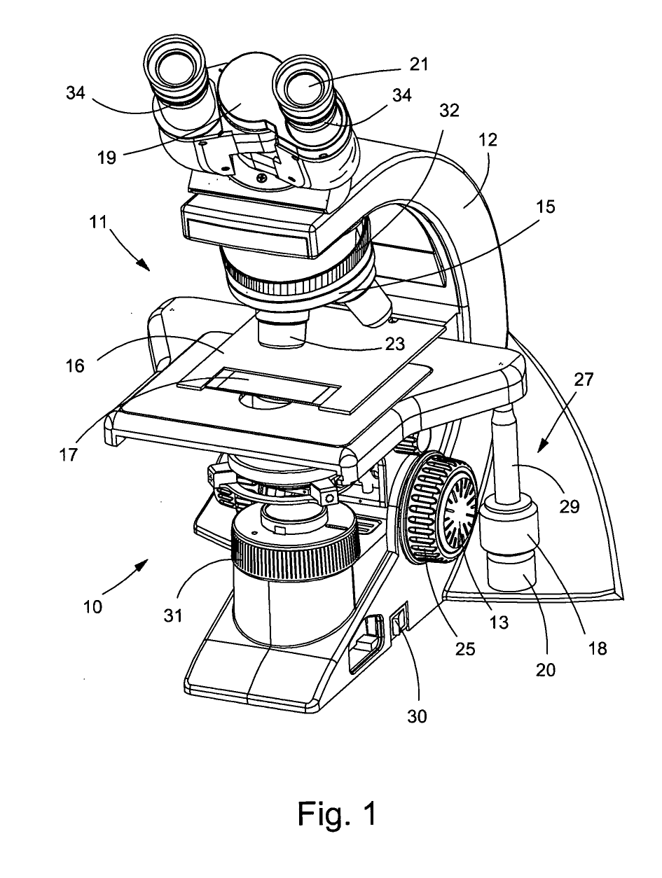

At the outset it should be noted that identical reference numbers on different figures represent similar structural elements. It should also be appreciated that, while a number of different embodiments and variations of the present invention are shown in the various drawings, the invention disclosed is not intended to be limited to these specific embodiments as the claims define a broader invention that can take many different shapes and structures. In the present disclosure and claims, it should be appreciated that “outer surface” is understood as the surface of the microscope or of microscope parts which can be regularly touched by the user of the microscope during normal operation and/or internal surfaces of a microscope that may not typically touched during normal operation. “Microbe” and “microbial” are intended to refer to microorganisms and other pathogens and may include but not be limited to: protozoa, algae, fungi, bacteria, virus, rickettsiae, etc. In the description below, the terms “up”, “down”, “forward”, “backward”, “left”, “right”, and their derivatives, should be interpreted from the perspective of one viewing the microscope shown in FIG. 1.

The antimicrobial outer surface can be obtained by painting or coating component surfaces with an antimicrobial compound, for example, a BioCote™ containing paint or coating. It should also be understood that the microscope components can be formed from materials comprising BioCote™, e.g., plastic, and the antimicrobial outer surface is achieved by mixing BioCote™ with the plastic material during fabrication of the microscope components. BioCote™ is an antimicrobial compound containing silver ions which is commercially available from BioCote, Ltd. of Wolverhampton, UK and which slowly releases silver ions from an inorganic matrix via an ion-exchange mechanism. The antimicrobial outer surface should also protect the microscope from fungus growing on it in humid climate. The complete microscope shows an antimicrobial outer surface, and the antimicrobial properties are not limited just to the touch points.

A conventional compound microscope is shown in perspective view in FIG. 1. Although the invention is suitable for use with a variety of light microscopes, it is useful to review the basic microscope structure and function to appreciate the present invention.

FIG. 1 illustrates the general structure of a compound microscope 10. The microscope broadly comprises a stand 12 to which all the component pieces of the microscope are mounted. In the embodiment shown, the viewing body 19 is a binocular, comprising the body and two eyepieces 21. The viewing body is not particularly germane to the invention, which is suitable for use with a microscope configured with any type of viewing body (monocular, binocular, trinocular, video, etc.). Objective lenses 23 are mounted to rotatable turret 15 or nosepiece grip 32. Microscope 10 further comprises microscope stage 11, which is mounted to stand 12. The microscope stage 11 comprises slide mount 16, and drive mechanism 27. Slide mount 16 is incorporated into stage 11 and enables movement of slide 17 holding the specimen to be viewed. Coarse focus knob 25 and fine focus knob 13 are mounted for rotation to stand 12. Rotating knobs 13 and 25 move stage 11 up and down, further moving slide 17 within the optical path of the microscope, allowing for focus at the specimen.

Stage 11 of the present invention supports slide 17. Drive 27 comprises drive shaft 29, first stage control knob 18, and second stage control knob 20. First stage positioning knob 18 effects movement of stage 11 in a forward and backward direction, whereas second stage positioning knob 20 effects movement of slide mount 16 in a leftward and rightward direction.

As mentioned above, the microscope comprises a plurality of components, consisting essentially of a stand 12, a stage 11 mounted to said stand 12, an eyepiece 21 provided at said stand 12 and several operating elements, for changing parameters of the microscope. At least a surface portion of the stand, the stage, the eyepiece or the several operating elements is provided with an antimicrobial outer surface. The antimicrobial feature of the outer surface is accomplished by a coating, paint or finish. Additionally, the components which are subjected to the exposure by a human hand can have an antimicrobial surface.

Components of a microscope which are often touched by the user of the microscope are, focus knobs 25, 13, stage controls knobs 18, 20, a power switch 30, a condensor control ring 31 or a nosepiece grip 32. It should be understood that these components can be produced by injection molding, or other processes.

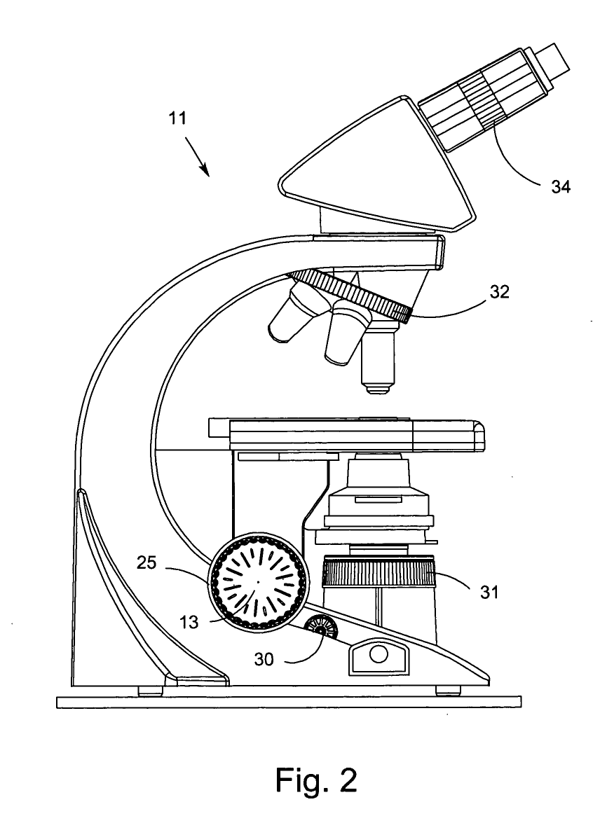

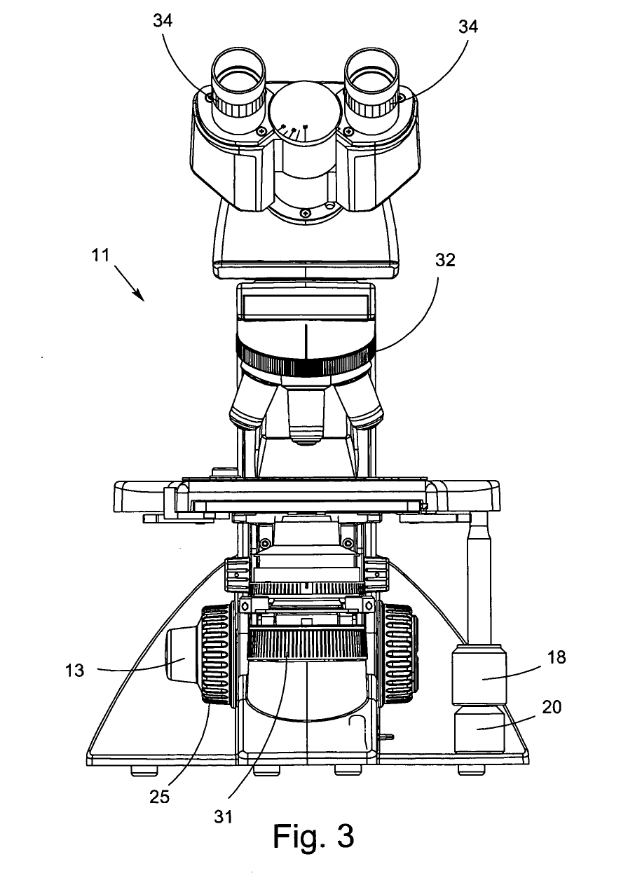

FIG. 2 shows a side view of a microscope and FIG. 3 shows a front view of a microscope. The microscope 11 comprises a plurality of components, which are provided with an antimicrobial surface. The components mentioned in FIGS. 2 and 3 are the microscope touch points which are often touched by the user in order to alter the settings of the parameters of a microscope 11. Consequently, it makes sense to provide the antimicrobial surface on stage controls 18, 20, on focus knobs 25, 13 on at least one power switch 30, on eye tubes 34, on a condensor control ring 31 or on a nosepiece grip 32.

The stage controls 18, 20, the focus knobs 25, 13, the at least one power switch 30, the eye tubes 34, the condensor control ring 31 and the nosepiece grip 32 are covered by a coating, a paint or a finish providing the antimicrobial surface. It is as well another possibility to form the stage controls 18, 20, the focus knobs 25, 13, the at least one power switch 30, the eye tubes 34, the condensor control ring 31 or the nosepiece grip 32 by an injection molding process. The injection molding material has all ingredients in order to provide the antimicrobial surface of the injection molded component.

What is claimed is:

1. A microscope comprising: a plurality of components, consisting essentially of a stand, a stage mounted to said stand, an eyepiece provided at said stand and several operating elements, for changing microscopic parameters, wherein at least a surface portion of the stand, the stage, the eyepiece or the several operating elements is provided with an antimicrobial outer surface.

2. The microscope as claimed in claim 1, wherein the antimicrobial outer surface is defined by a coating, a paint or a finish.

3. The microscope as claimed in claim 1 wherein the antimicrobial outer surface is defined by a surface of an injection molded component of the microscope.

4. The microscope as claimed in claim 1 wherein the antimicrobial outer surface is established on focus knobs provided at the stand.

5. The microscope as claimed in claim 1 wherein the antimicrobial outer surface is established on stage controls knobs provided at the stage.

6. The microscope as claimed in claim 1 wherein the antimicrobial outer surface is established on a power switch.

7. The microscope as claimed in claim 1 wherein the antimicrobial outer surface is established on eye tubes.

8. The microscope as claimed in claim 1 wherein the antimicrobial outer surface is established on a condensor control ring.

9. The microscope as claimed in claim 1 wherein the antimicrobial outer surface is established on a nosepiece grip.

10. A microscope comprising a plurality of components, characterized in that an antimicrobial surface is provided on stage controls, on focus knobs, on at least one power switch, on eye tubes, on a condensor control ring and on a nosepiece grip.

11. The microscope as claimed in claim 10, wherein the stage controls, the focus knobs, the at least one power switch, the eye tubes, the condenser control ring and the nosepiece grip are covered by a coating, a paint or a finish providing the antimicrobial surface.

12. The microscope as claimed in claim 10, wherein the stage controls, the focus knobs, the at least one power switch, the eye tubes, the condensor control ring and the nosepiece grip are injection molded to provide the antimicrobial surface.

13. A microscope component comprising an antimicrobial surface.

14. The microscope of claim 13 wherein the antimicrobial outer surface properties are provided by integrating an antimicrobial compound into the structural matrix of said microscope component during fabrication thereof.

15. The microscope of claim 14 wherein said antimicrobial compound is integrated during an injection molding process.

16. The microscope of claim 13 wherein the antimicrobial outer surface is provided by a surface treatment.

17. The microscope as claimed in claim 16 wherein said surface treatment comprises paint, powder coat, or finish.
